(19) United States
(12) Patent Application Publication
(10) Pub. No.: US 2003/0183595 A1
(43) Pub. Date: Oct. 2, 2003

(54) Air inlet sleeve of baby's bottle

(76) Inventor: Der-Da Huang, Chang hua (TW)

Correspondence Address: Der-Da Huang, 235 Chung-Ho, Box 8-24, Taipei, TW

(21) Appl. No.: 10/107,729

(22) Filed: Mar. 28, 2002

(51) Int. Cl. A61J 9/04

(52) U.S. Cl. 215/11.5

(57) ABSTRACT

An air inlet sleeve of a baby's bottle has a hollow sleeve capable of being installed to an opening of a baby's bottle. An annular neck protrudes from a periphery of the distal end of the sleeve. The annular neck inserts into a lower section of a nipple matched to the baby's bottle and then a cover of the nipple covers and positions the nipple. An annular channel is formed between an inner wall and an outer wall of the sleeve. A bottom of the channel has a plurality of air inlet holes which are arranged around the round bottom. Air entering into the nipple will flow along the annular channel, then output from some of the air inlet holes which has a lower liquid pressure; thereby, as a user sucks the liquid in the baby's bottle, the user will not suck the air.

### FIELD OF THE INVENTION

The present invention relates to an auxiliary tool of a baby's bottle, and particularly to an air inlet sleeve of a baby's bottle, as a user sucks the liquid in the baby's bottle, the user will not suck the air in the baby's bottle.

### BACKGROUND OF THE INVENTION

The primary concern for designing a nipple is to be sucked by a baby easily and comfortably, and moreover, the output liquid flow is controllable. In the process of sucking the liquid in a baby's bottle, the pressure in the bottle will be lower than that out of the bottle. If no air flows into the bottle, the liquid in the bottle cannot be sucked further. Moreover, a lower pressure in the bottle will cause the liquid therein to generate bubbles. To improve this problem, an air inlet valve is installed on a flange at a lower side of the bottle. But the inlet valve is short so that the inlet air from the valve is concentrated in the lower side of the nipple, and thus the baby sucking the nipple will also suck the air and thus it is possible that the baby will have a plenitude and thus feel uneasy.

To improve this problem, the applicant disclosed a prior art “NIPPLE FOR NURSING BOTTLES”, U.S. Pat. No. 5,678,710, as illustrated in FIGS. 1, 1A and 1B.

In FIG. 1, it is illustrated that a tube is extended from a lower side of a nipple. Referring to FIGS. 1A and 1B, in FIG. 1A, the tube is at an upper position of a baby's bottle, while in FIG. 1B, the tube is at a lower position of the baby's bottle. The liquid pressure applied upon the opening of the tube illustrated in FIG. 1A is apparently smaller than that applied upon the opening of the tube illustrated in FIG. 1B. Thereby, the air in FIG. 1A will release to the upper space filled with air through a shorter time interval than that illustrated in FIG. 1B.

In above mentioned prior art, a protruding tube 2 is used to extend the valve so that as air into the baby's bottle P will leave from the lower channel N1 below the nipple N. It can prevent air from being sucked by the baby and thus no plenitude occurs. However, some air from the protruding tube will mix with the liquid in the baby's bottle. When too much air is mixed with the liquid and then is sucked by a baby sucking the nipple, the baby will still get a plenitude. However, this phenomenon can not be found by eyes easily.

In one prior art, an isolating air inlet tube installed between the nipple cover and the opening of a bottle is developed for guiding air out of the bottle to the bottom of the nipple, such as U.S. Pat. No. 5,779,071, “Nursing Bottle With An Air Venting Structure” and U.S. Pat. No. 5,570,796, “Nursing Bottle With An Air Venting Structure”. However, this prior art is an independent element and thus must be further assembled. Furthermore, some other complicated components are necessary to be added. Thus the cost and price are high. Furthermore, it can not be used to general baby's bottles and the user must assemble it to a baby's bottle, while the assembly process is complicated and thus is not suitable for every user.

### SUMMARY OF THE INVENTION

Accordingly, the primary object of the present invention is to provide an air inlet sleeve of a baby's bottle having a hollow sleeve capable of being installed to an opening of a baby's bottle. An annular neck protrudes from a periphery of the distal end of the sleeve. The annular neck inserts into a lower section of a nipple matched to the baby's bottle and then a cover of the nipple covers and positions the nipple. An annular channel is formed between an inner wall and an outer wall of the sleeve. A bottom of the channel has a plurality of air inlet holes which are arranged around the round bottom. Air entering into the nipple will flow along the annular channel, then outputs from some of the air inlet holes which has a lower liquid pressure; thereby, as a user sucks the liquid in the baby's bottle, the user will not suck the air.

Another object of the present invention is to provide an air inlet sleeve of a baby's bottle, wherein at least one of the air inlet holes in the lower section of the annular channel is extended with a hollow post. A hollow extending tube having a predetermined length is at a lower side of one of the hollow posts. As a result, the air flowing into the cover can further enter into the hollow extending tube and then flows out of an opening at a lower end of the hollow extending tube to a lower section in the baby's bottle.

A further object of the present invention is to provide an air inlet sleeve of a baby's bottle, wherein an embedding portion is extended form the annular neck. A suction soft tube with a movable piece is engaged to the embedding portion and a suction head is connected to the suction soft tube. Thereby, the suction soft tube is used as an auxiliary tool so that a baby suck liquid through the suction soft tube.

The various objects and advantages of the present invention will be more readily understood from the following detailed description when read in conjunction with the appended drawing.

### BRIEF DESCRIPTION OF THE DRAWINGS

FIG. 1 shows one prior art design of the present invention, where FIGS. 1A and 1B show two states of the prior art.

FIG. 2 shows an exploded perspective view of one embodiment of the present invention.

FIG. 2A is a cross sectional view showing the hollow sleeve 3 of the present invention.

FIG. 2B is an assembled cross sectional view of the present invention.

FIG. 3 shows the air suction of the present invention.

FIG. 4 is an exploded perspective view of the second embodiment of the present invention.

FIG. 4A shows one component of the second embodiment.

FIG. 4B is one assembled view of the second embodiment of the present invention.

FIG. 4C is another assembled view of the second embodiment of the present invention.

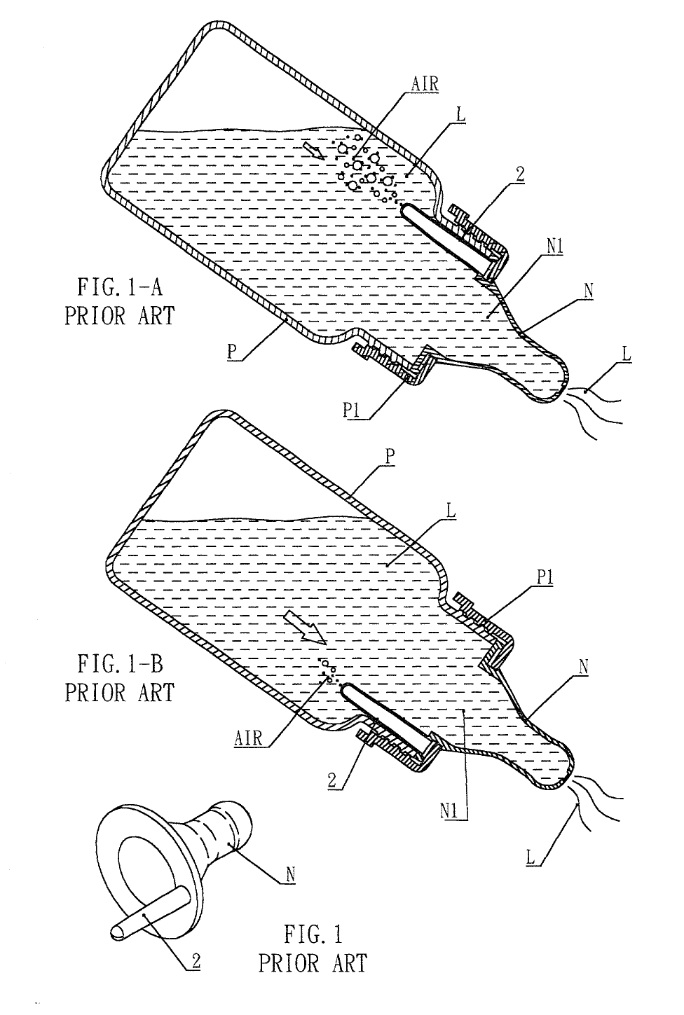

### DETAILED DESCRIPTION OF THE PREFERRED EMBODIMENTS

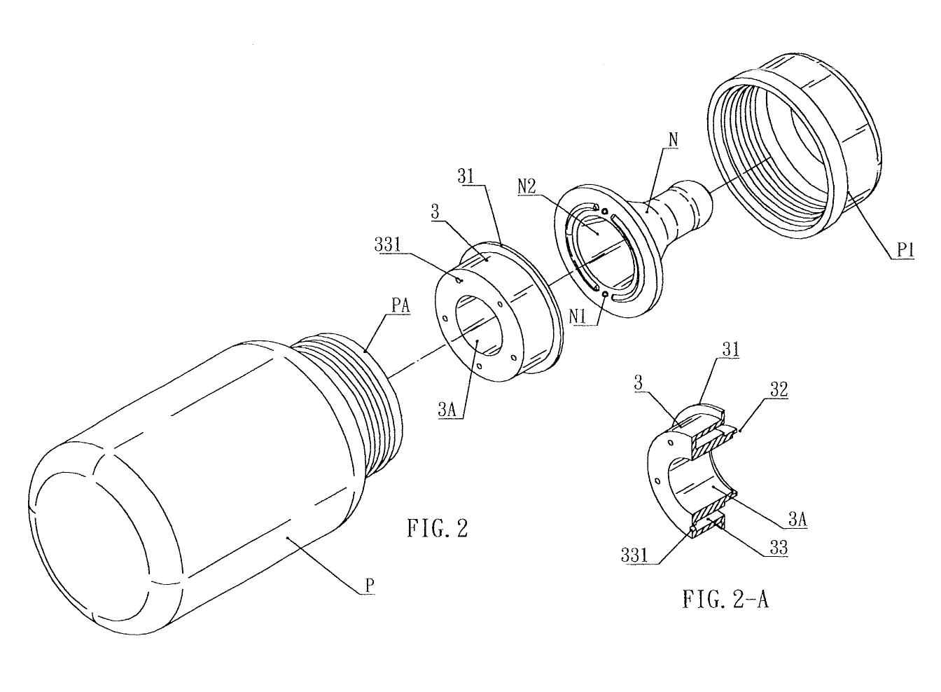

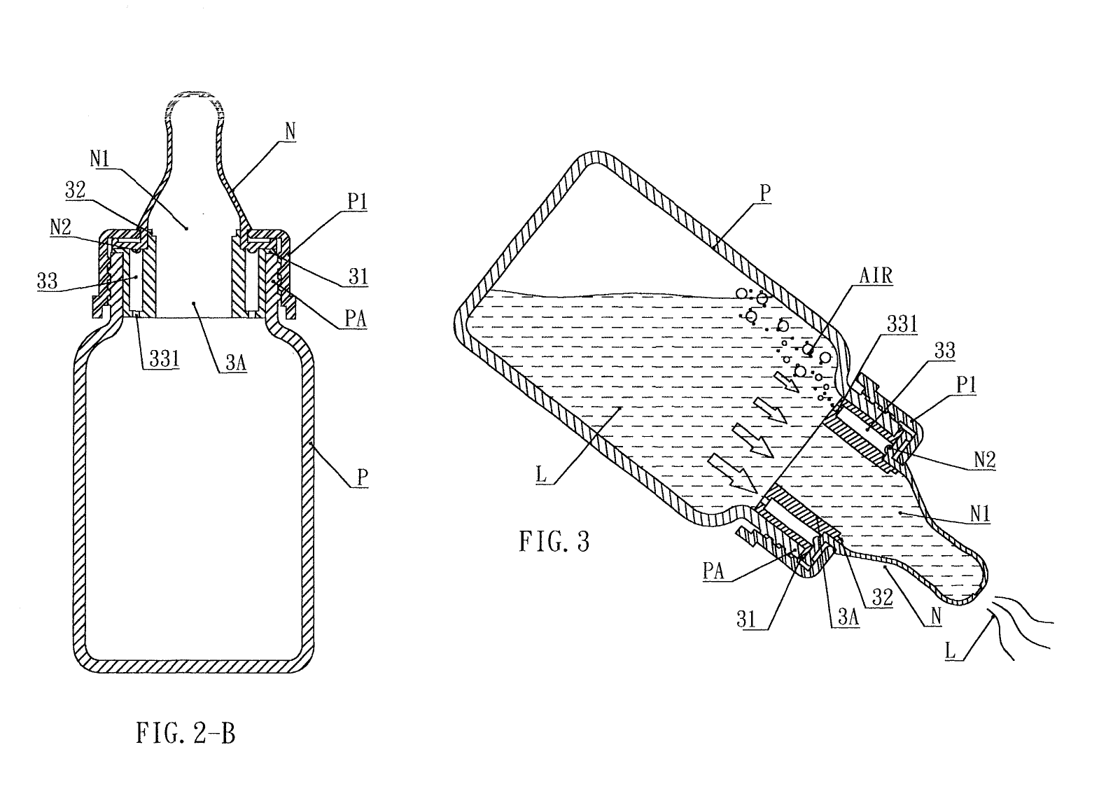

Referring to FIGS. 2, 2A and 2B, the present invention has a hollow sleeve 3 which can be installed to an opening PA of a prior art baby's bottle P. The sleeve 3 has an extending base 31 extending from a lateral side at a distal end of the sleeve 3. The extending base 31 can be used to resist against the opening 3A of the baby's bottle. An annular neck 32 protrudes from a periphery of the distal end of the sleeve 3. The annular neck 32 inserts into a lower section of the nipple of the baby's bottle and then a cover P1 of the nipple covers and positions the nipple.

An annular channel 33 is formed between the inner wall and outer wall of the sleeve 3. The bottom of the channel 33 has a plurality of air inlet holes 331 which are arranged around the round bottom.

With reference to FIGS. 2B and 3, the annular channel 33 is aligned to an air inlet valve N2 at a lower section of the nipple. Air inputted from the air inlet valve N2 can be guided into to the annular channel 33 and then to the air inlet holes 331 to vent out of the holes. The length of the sleeve 3 is at least equal to the length of a threaded tube PB at the opening of the baby's bottle P. Therefore, the air inputting the baby's bottle P from the air inlet holes 331 will be away from the suction section below the liquid channel N1 of the nipple N. As a result, the air will not be sucked as the liquid in the baby's bottle is sucked.

Referring to FIG. 3, a usual case is illustrated, wherein a baby's bottle P is arranged obliquely. The air inlet holes 331 are arranged in a high pressure section at a deep side below the liquid surface and in a low pressure section at a shallow side below the liquid surface. In FIG. 3, a plurality of arrows are illustrated, which indicated the pressure applied upon the air inlet holes 331. The longer the arrow, the larger the pressure applied upon the air inlet hole. When air flow into the channel 33. The air will vent out from the air inlet holes near the shallow side since the air is light and thus it will vent out from a lower pressure section. Then air will become bubbles and move upwards along a path near an upper side of the baby's bottle and then releases out to the space filled with air. As a result, the baby will not suck air into the stomach. The time interval from the air inlet holes to the space filled with air is short. Therefore, the pressure in the baby's bottle is balanced in a very short time interval and thus the baby can suck the liquid in the bottle easily.

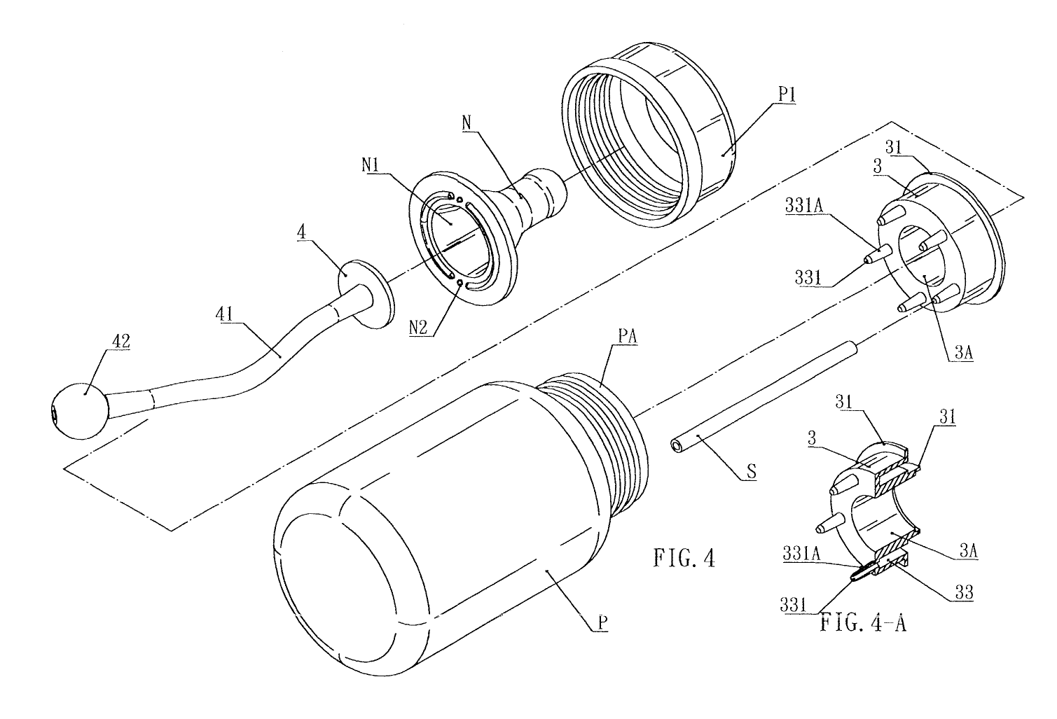

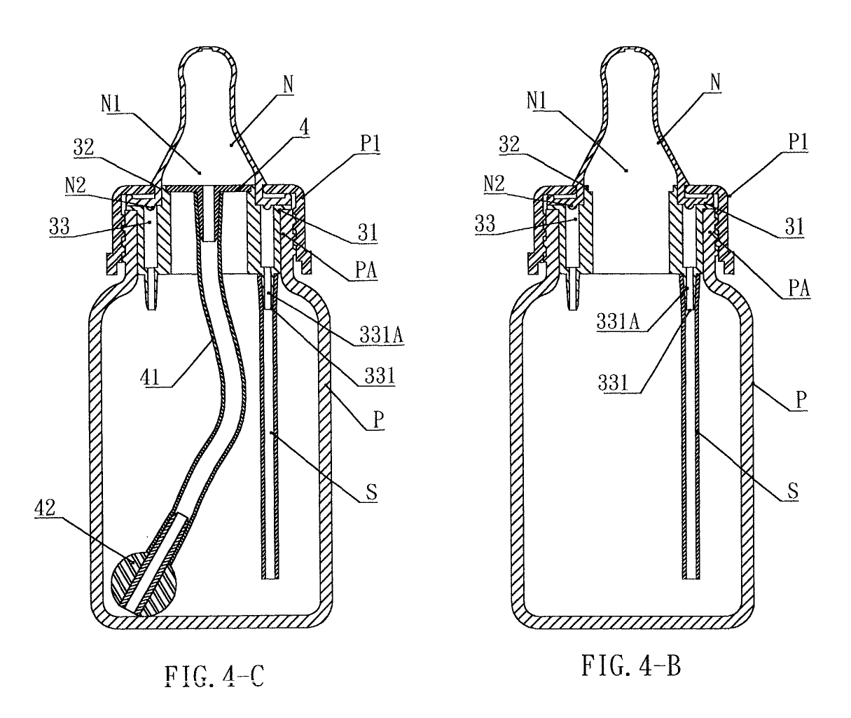

Referring to FIGS. 4, 4A and 4B, each of the air inlet holes 331 in the lower section of the annular channel 33 is extended with a hollow post 331A. Moreover, a hollow extending tube S having a predetermined length can be connected to the lower side of the hollow post. As a result, the air flowing into the cover can further enters into the hollow extending tube S and then flows out of an opening at a lower end of the hollow extending tube S to a lower section in the baby's bottle. Thus, the baby will not suck the air in the baby's bottle.

With reference to FIGS. 4, 4A and 4C, the present invention can be used with a suction tube. In that, an embedding portion 321 is extended form the annular neck 32. The suction soft tube 41 with a movable piece 4 can be engaged to the embedding portion 321 and a suction head is connected to the suction soft tube 41. Thereby, the suction soft tube 41 is used as an auxiliary tool so that a baby may suck liquid easily despite the direction of the baby's bottle.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An air inlet sleeve of a baby's bottle having a hollow sleeve capable of being installed to an opening of a baby's bottle; the sleeve having an extending base extending from a lateral side at a distal end of the sleeve; the extending base being used to resist against an opening of the baby's bottle; an annular neck protruding from a periphery of the distal end of the sleeve; the annular neck inserting into a lower section of a nipple matched to the baby's bottle and then a cover of the nipple covering and positioning the nipple; characterized in that:
an annular channel is formed between an inner wall and an outer wall of the sleeve; a bottom of the channel has a plurality of air inlet holes which are arranged around the round bottom; and
wherein air entering into the nipple will flow along the annular channel, then output from some of the air inlet holes which have a lower liquid pressure; thereby, as a user sucks the liquid in the baby's bottle, the user will not suck the air.

2. The air inlet sleeve of a baby's bottle as claimed in claim 1, wherein a length of the sleeve is at least equal to the length of a threaded tube at the opening of the baby's bottle; therefore, air inputting the baby's bottle from the air inlet holes will be away from a suction section below the nipple; as a result, the air will not be sucked with the liquid in the baby's bottle.

3. The air inlet sleeve of a baby's bottle as claimed in claim 1, wherein at least one of the air inlet hole in the lower section of the annular channel is extended with a hollow post; as a result, the air flowing into the cover further enters into the hollow post and then flows out of an opening at a lower end o the hollow post to a lower section in the baby's bottle.

4. The air inlet sleeve of a baby's bottle as claimed in claim 3, wherein at le one of the air inlet hole in the lower section of the annular channel is extended with a hollow post; a hollow extending tube having a predetermined length is a lower side of one of the hollow post; as a result, the air flowing into the cover further enters into the hollow extending tube and then flows out of an opening at a lower end of the hollow extending tube to a lower section in the baby's bottle.

5. The air inlet sleeve of a baby's bottle as claimed in claim 1, wherein an embedding portion is extended form the annular neck; a suction soft tube with a movable piece is engaged to the embedding portion and a suction head is connected to the suction soft tube; thereby, the suction soft tube is used as an auxiliary tool so that a baby suck liquid through the suction soft tube.
